(19) United States
(12) Patent Application Publication
(10) Pub. No.: US 2019/0082241 A1
(43) Pub. Date: Mar. 14, 2019

(54) METHOD FOR OPERATING A CONSUMPTION METER SYSTEM AND CONSUMPTION METER

(71) Applicant: DIEHL METERING SYSTEMS GMBH, Nuernberg (DE)

(72) Inventors: Achim SCHMIDT, Weissenohe (DE); Matthias SCHAAF, Pleinfeld (DE)

(21) Appl. No.: 16/130,442

(22) Filed: Sep. 13, 2018

(30) Foreign Application Priority Data
Sep. 13, 2017 (DE) 10 2017 008 593.5

(51) Int. Cl. H04Q 9/00; H04L 29/06

(52) U.S. Cl. CPC H04Q 9/00; H04Q 2209/60; H04L 63/18; H04L 63/0428

(57) ABSTRACT

A method operates a consumption meter system, in which the consumption of a supply medium by a consumer is determined using a consumption meter. A consumption value is transmitted in the form of data between the consumption meter and a first receiver. The first receiver is assigned to a higher-level supplier and the data are transmitted between the consumption meter and the first receiver via a first data channel. The data are encrypted on the meter side using a first key for transmission via the first data channel. A second data channel is provided for transmitting the data between the consumption meter and a second receiver. The data are encrypted on the meter side by a second key for transmission via the second data channel.

### CROSS-REFERENCE TO RELATED APPLICATION

This application claims the priority, under 35 U.S.C. § 119, of German application DE 10 2017 008 593.5, filed Sep. 13, 2017; the prior application is herewith incorporated by reference in its entirety.

### BACKGROUND OF THE INVENTION

### Field of the Invention

The present invention relates to a method for operating a consumption meter system and also a consumption meter for determining consumption.

Intelligent consumption meters, also referred to as smart meters, are consumption-metering devices incorporated into a supply network of a higher-level supplier, e.g. for gas, water, power or heat quantity, which indicate the actual consumption to the respective connection user or consumer. Generic smart meters are normally installed in commercial or residential units of the respective consumer. The data generated there can also be read directly by the supplier in many different ways. The metering data can be read, for example, via the power network (powerline) or via a radio link. This removes the need for manual meter readings and shorter-term billing can be undertaken by the supplier according to actual consumption. Shorter-term reading intervals in turn enable a more accurate linkage between end customer tariffs and the development of trading prices for electricity. The supply networks can also be substantially more effectively utilized.

Consumption is normally determined on the basis of a metering arrangement of the smart meter, e.g. a metering arrangement for determining flow rate. Generic smart meters furthermore have a control and evaluation unit for generating the consumption data and for controlling the smart meter, and also a transceiver device for transmitting the data, e.g. to the central control room or to a data collector of the supplier.

Smart meters are increasingly used in consumer applications also, such as smart home controllers and home automation networks. However, due to safety risks in particular, this normally involves additional smart meters which are to be installed by the consumer and are installed in the supply network along with the smart meter of the supplier in order to determine consumption. Generic smart home controllers serve to improve the quality of home and life and also security, whereby devices in daily use (e.g. entertainment systems, lights, blinds, alarm systems, heating, refrigerator and coffee machine) and their operating processes are networked and automated. Smart meters within smart home controllers furthermore serve to carry out an intelligent regulation of energy consumption and to indicate current consumption data to the consumer, e.g. via an operating panel of the smart home controller.

Published, non-prosecuted German patent application DE 10 2012 203 354 A1 (corresponding to U.S. Pat. Nos. 9,553,869 and 9,491,172) describes a method for personalizing a smart meter in which the consumption data are forwarded to the supplier via a security module built into the smart meter. The security module communicates here with a trusted instance or with the supplier. The connection to the supplier is set up in a wireless or wired manner via a data channel. The supplier is authenticated on the security module via a cryptographic protocol, such as e.g. a symmetric key or an asymmetric key. The consumption meters transmit the consumption data exclusively via the data channel in the radio communication network of the network operator (e.g. the energy supplier). End-to-end security is provided on this data channel, i.e. the data are encrypted by the consumption meter and are decrypted by the supplier with the associated key following transmission or reception. As a result, the data cannot be used by third parties. Conversely, a connection of a further receiver, such as e.g. a consumer application of the consumer, is, however, possible only if the supplier discloses the key to the consumer, thereby creating a means of ingress for third parties. This represents a threat to the overall safety of the supply network. Furthermore, the characteristics of the data channel of the supplier are normally unsuitable for consumer applications, since they are tied to the conditions of the supplier.

### SUMMARY OF THE INVENTION

The object of the present invention is to provide a method in which the data from the consumption meter can be transmitted in a simple manner, securely and economically to a plurality of receivers.

The aforementioned object is achieved by the overall teaching of the independent claim and of the subordinate claim. Appropriate designs of the invention are claimed in the sub claims.

According to the invention, a second data channel is provided to transmit the data between the consumption meter and a second receiver. The data are transmitted here via the second data channel in encrypted form by use of an additional second key, i.e. the second data channel represents an existing communication path which is end-to-end encrypted. This offers the advantage that the data can be transmitted in a simple manner via the second data channel to an additional second receiver without the latter knowing the first key. The second data channel can be configured individually so that no attack vector occurs at device level of the consumption meter system. The security of the consumption meter system is thereby increased to a particular extent. The data required by the supplier can furthermore be transmitted in a suitable manner via the first data channel, i.e. the data quantity and transmission frequency can e.g. be kept low on this channel. In addition, the consumer can compile or configure the data for himself individually and can retrieve the data by means of the second data channel. In addition, the transmission type can be adapted, e.g. in terms of the radio communication standard, frequency, channel occupancy or the like, for the respective data channel without impacting on the other data channel. The solution according to the invention can furthermore be installed or retrofitted economically and simply in existing systems, e.g. in the form of a firmware update of the consumption meter.

The data are appropriately encrypted on the meter side with the first and/or second key before transmission and are decrypted by the first receiver using the first key and/or by the second receiver using the second key after transmission. An end-to-end security of the first and second data channel is thereby guaranteed.

The first key and/or the second key is/are preferably a symmetric or an asymmetric key. If a symmetric key is used, i.e. the consumption meter and the respective receiver know or possess the key, either the same keys or different, mutually calculable, keys can be used on the transmitter side and on the receiver side. Conversely, an asymmetric key can also be used which contains a public and private key (key pair). In a preferred manner, the second key, e.g. the symmetric key, is disposed on the consumption meter so that the latter is accessible only to the consumer and to the supplier or installer in order to avoid manipulations. Conversely, the private key of the asymmetric key is preferably private for the receiver, i.e. it is communicated e.g. to the consumer so that the consumption meter can encrypt with the public key. Security is thereby increased to a particular extent.

According to one preferred configuration of the present invention, the second receiver contains a consumption application, such as e.g. a home automation network or a smart home controller. Through the incorporation of the consumption meter of the supplier into the smart home controller of the consumer, the consumer can obtain e.g. the current consumption or the temperature of the consumption medium in a simple manner without installing an additional smart meter. Additional costs can thereby be avoided.

The second data channel may appropriately be a one-way data channel via which the data are transmitted e.g. from the consumption meter to the consumer application. The data from the consumption meter can thereby be transmitted to the consumer application, but no data can be transmitted from the consumer application or from a third party to the consumption meter. This offers the advantage that no additional means of ingress to the consumption meter system is created, since the consumption meter is configured, e.g. is restricted, only for transmission and not for reception via the second data channel. Security is thereby additionally increased.

Alternatively, the second data channel may be a two-way data channel via which the data are transmitted e.g. from the consumption meter to the consumer application and from the consumer application to the consumption meter. The consumption meter can thereby be controlled directly by the consumer application. As a result, information from the supplier, for example, can also be transmitted via the consumption meter to the consumer application. The consumption meter or the second data channel can furthermore be configured via the consumer application.

A data connection, such as e.g. an Internet connection or a power line, can appropriately be provided between the first receiver and the second receiver. The data connection can be configured here to transmit data from the first receiver to the second receiver. These data can then be transmitted from the second receiver via the second data channel to the consumption meter. Larger data volumes could thus also be transmitted in a simple manner to the consumption meter. A firmware update, for example, could thereby be carried out, e.g. in that the firmware update is loaded by the supplier onto the consumption meter via an Internet session with the consumer application. Maintenance costs and personnel expenditure can thereby be reduced to a considerable extent. Similarly, data from the consumption meter can also be transmitted via the consumer application to the supplier or to the central unit. Additional transmission sessions can thereby be set up.

The data, preferably the selection of the data which are transmitted via the second channel are furthermore configurable by the first receiver or the supplier and/or by the second receiver or the consumer. The transmission frequency and consumption parameters, for example, can be set here. The consumption meter can be configured in a practical manner, e.g. by the central unit via the first data channel or by the consumer application via the second data channel.

The second key is preferably extractable and/or readable via the consumption meter. This can be done in a simple manner in that the second key is printed e.g. as an identification number or password on a label of the consumption meter or is stored in a memory of the consumption meter or is readable from a display.

The data channel may appropriately be a logical and/or physical data channel. It is thereby enabled, for example, that the physical data channel can be used jointly transmitting the data, whereas the logical data channel to the supplier can be encrypted individually for each consumption meter.

The data are preferably consumption data which have been determined by the consumption meter and/or control data and/or operating data which serve to control or configure the consumption meter.

The consumption meter system preferably contains a plurality of consumption meters, wherein the data from a group of consumption meters are transmitted to the first receiver, in particular via a jointly used first physical data channel, wherein the logical data channel is encrypted in each case individually for each meter. The data from the group of consumption meters can furthermore be transmitted to a second receiver using a jointly used second data channel. All consumption meters in the group possess the first key for transmitting the data via the first data channel and the second key for transmitting the data via the second data channel.

The supply medium is preferably gas, water, electricity and/or heat quantity.

The present invention secondarily claims a consumption meter for determining the consumption of a supply medium by a consumer. The consumption meter contains means for determining consumption, an energy supply, a control and evaluation unit to generate data from the specific values of the means for determining consumption, and also a transceiver device to transmit the data. The data are transmitted here from the transceiver device via a first data channel between the consumption meter and a first receiver (e.g. the central control room of the supplier, a data collector or the like). A second data channel is furthermore provided between the consumption meter and a second receiver (e.g. a consumer application, a smart home controller or the like) via which the transceiver device transmits the data between the consumption meter and the second receiver. The data are encrypted by a first key for transmission via the first data channel and by a second key for transmission via the second data channel.

The means for determining consumption preferably contain a metering arrangement for determining the flow rate of a fluid (e.g. gas or water), the input and/or extracted heat energy or the quantity of an input and/or extracted electrical quantity (e.g. electricity, energy, work, electric charge). The consumption meter is accordingly a water, gas, heat quantity and/or electricity meter.

The keys can appropriately be stored in a memory of the consumption meter so that e.g. the control and evaluation unit encrypts the data by a processor before transmission in such a way that the data are decryptable by the first receiver using the first key and/or by the second receiver using the second key after transmission. End-to-end security is thereby guaranteed in each case on the first and second data channel, as a result of which transmission security is improved to a particular extent.

Other features which are considered as characteristic for the invention are set forth in the appended claims.

Although the invention is illustrated and described herein as embodied in a method for operating a consumption meter system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a first design of a consumption meter system according to the prior art;

FIG. 2 is a simplified schematic representation of a further design of the consumption meter system according to the prior art;

FIG. 3 is a simplified schematic representation of a design of the consumption meter system according to the invention; and

FIG. 4 is a diagrammatic, sectional view of the design of the consumption meter system according to the invention.

### DETAILED DESCRIPTION OF THE INVENTION

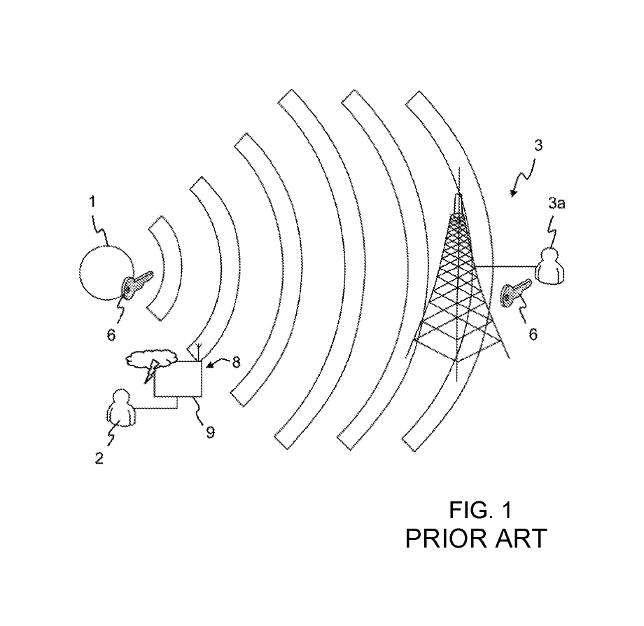

Referring now to the figures of the drawings in detail and first, particularly to FIG. 1 thereof, there is shown a consumption meter system according to the prior art. In the consumption meter system, a consumption meter 1 transmits consumption data for billing purposes to a first receiver 3, such as e.g. the central control room of a supplier 3a. An end-to-end encryption (end-to-end security) is present on this communication channel or data channel, i.e. the data are encrypted by the consumption meter 1 and are decrypted in the central control room of the supplier 3a (head end) with an associated first key 6. The data cannot therefore be used by third parties on the transmission path. A consumption data tapping, e.g. by a second receiver 8, is therefore not possible without additional measures.

However, third parties are also the end consumers or the consumer 2 whose consumption of a supply medium, e.g. electricity, heat, gas or water, is recorded with the respective consumption meter 1. A connection of the consumption meter 1 to a second receiver 8 or to a data infrastructure of the consumer 2, such as e.g. a smart home controller 9, is therefore possible only if the supplier 3a discloses its key 6 to the consumer 2. This poses a threat to the overall security of the supplier network, particularly as individual keys are rarely maintained under normal circumstances for one consumption meter 1, but rather group keys are maintained for a plurality of consumption meters 1. Other characteristics of the data channel, such as e.g. the data rate and the timeliness of the metered value, are furthermore tied to the conditions of the supplier 3a. These are usually unsuitable e.g. for applications of the consumer 2, such as the smart home controller 9 with consumption monitoring.

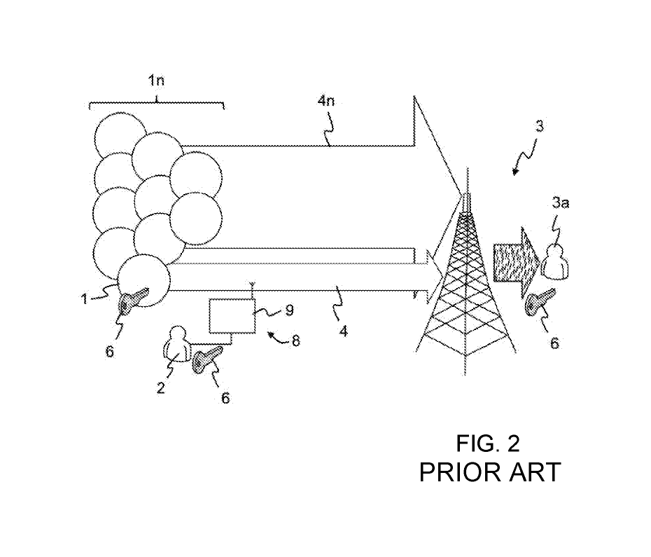

As shown in FIG. 2, the first key 6 of the supplier 3a can be shared with the consumer 2 in order to enable the consumer to access the data of the consumption meter 1. As a result, however, only the access problem is solved, but not the requirement with regard to data granularity and the timeliness of the data. FIG. 2 thus shows a high transmission volume in the transmission infrastructure of the supplier 3a which occurs due to the multiplicity of consumption meters 1 if the consumption meter 1 is extended by a multiplicity of consumption meters 1. Due to the common channel, there are two possible scenarios regarding the data content: The consumer 2 can either use only the data which the supplier 3a allows to be transmitted for its own purposes, or the supplier 3a must handle a higher data volume so that it can allow the data individually compiled for the consumer 2 to be transmitted. Both scenarios, however, present considerable shortcomings in terms of transmission security, user-friendliness and/or data management.

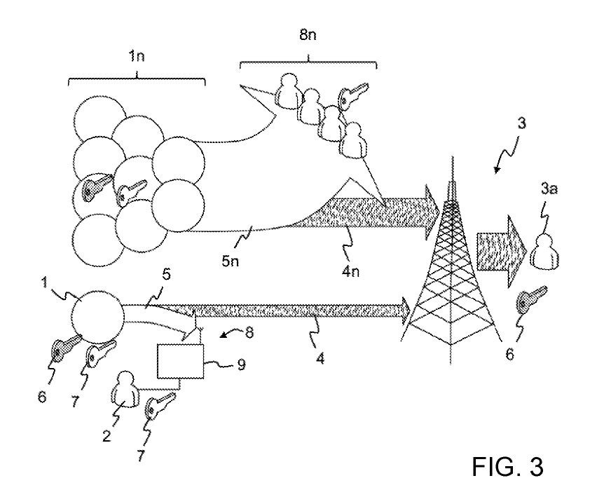

FIG. 3 shows a consumption meter system according to the invention which contains a plurality of consumption meters 1. Here, one consumption meter 1 in each case offers a second data channel 5 in order to make data available for the second receiver 8 or the smart home controller 9 of the consumer 2. These data are encrypted on the meter side with at least one further second key 7. An individual data rate of the metered values can thereby be provided and a secure database can be guaranteed for the consumer 2. This database thus offers both secrecy and integrity, and is not potentially compromised by a preprocessing of an unauthorized third party.

The consumption meter system can thus continue to be operated optimally for the supplier 3a in terms of transmission efficiency and data security (supplier access). The legal obligations of the supplier 3a regarding data protection, such as e.g. data economy and security obligation, are also supported. Since the second data channel 5 is a one-way channel, no new attack vector also occurs at device level of the consumption meter system. The security requirement of the consumer 2 is thus substantially supported. The data are uncorrupted for the consumer 2 due to the dedicated second data channel 5. It is thereby also possible for the consumer to use a higher data rate for his own purposes without giving third parties the opportunity to carry out personal consumption pattern analyses.

The method according to the invention furthermore offers the facility for a group of consumption meters 1n to use a common first data channel 4n to transmit the data between the group of consumption meters 1n and the first receiver 3. A common second data channel 5n can furthermore be provided to transmit the data between the group of consumption meters 1n and the second receiver 8 or a group of second receivers 8n. All consumption meters in the group 1n logically possess the first key 6 for transmitting the data via the first data channel 4n and the second key 7 for transmitting the data via the second data channel 5n. The data channel 4n can be designed as a physical data channel which is used jointly for the data transmission, but is encrypted on an individual meter basis, i.e. different logical data channels 4n are provided in each case for the consumption meters in the group 1n. This design can be used, for example, to incorporate the respective consumption meters 1 of a household, e.g. gas meter, water meter, electricity meter and heat quantity meter, as a group of consumption meters 1n via the common second data channel 5n into the smart home controller 9 of the household or to provide a landlord as part of a group of receivers 8n with information for incidental cost billing.

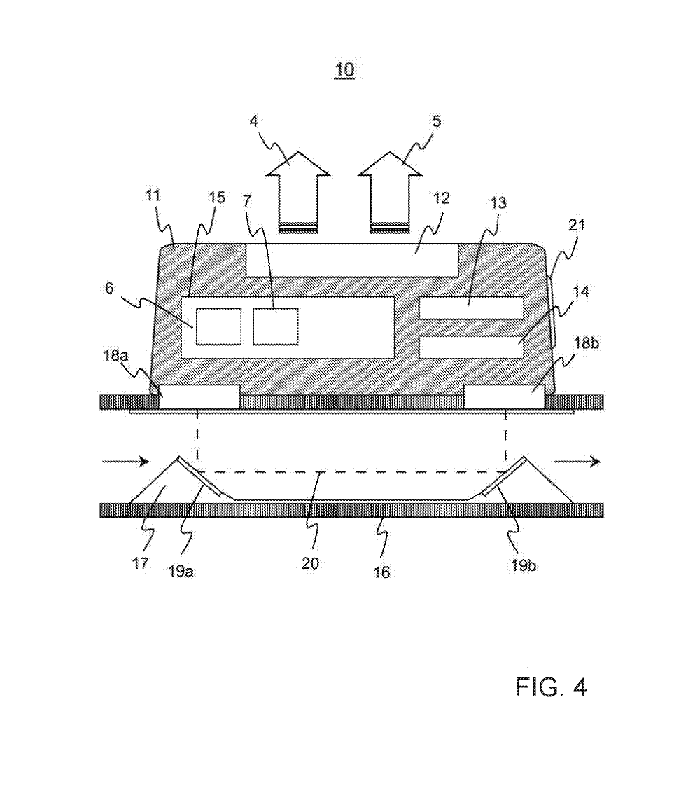

Reference number 10 in FIG. 4 denotes a consumption meter according to the invention which is configured as a water meter. The consumption meter 10 contains a connection housing 16 with which the consumption meter 10 can be installed in the water pipe network of the consumer 2. The direction of flow of the water is shown in FIG. 4 with black arrows. The consumption meter 10 furthermore contains an ultrasonic metering arrangement as a means for determining consumption in order to determine the flow rate of the water. Part of the ultrasonic metering arrangement is formed by two ultrasonic transducers 18a, 18b between which a U-shaped ultrasonic metering path 20 is located which is diverted on diverting devices 19a, 19b, such as e.g. mirrors or reflectors. The diverting devices 19a, 19b and the ultrasonic metering path 20 are located inside a metering insert 17 which is installable or insertable in a simple manner as a pre-assemblable component into the connection housing 16 of the consumption meter 10. The consumption meter 10 appropriately contains an energy source which is configured according to FIG. 4 as a battery 14. Alternatively, the consumption meter 10 can also be supplied with energy via an accumulator or a powerline connection. Consumption is determined in the consumption meter 10, e.g. in that ultrasonic signals are transmitted by the ultrasonic transducers 18a, 18b along the ultrasonic metering path 20. After passing along the ultrasonic metering path 20, the ultrasonic signals are received by the respective other ultrasonic transducer 18a, 18b. Consumption can be determined e.g. on the basis of a transit time difference method or a different method for determining flow rate known from the prior art.

The consumption meter 10 furthermore comprises a control and evaluation unit 11 with a processor 13 which is configured to generate data from the metered values and control the consumption meter 10. In addition, the consumption meter 10 contains a transceiver device 12 which serves, in particular, to transmit the data to the first receiver 3 and/or second receiver 8. The data can be transmitted and/or received here by the transceiver device 12 via the first data channel 4 between the consumption meter 10 and the first receiver 3 and/or the second data channel 5 between the consumption meter 10 and the second receiver 8. The consumption meter 10 furthermore contains a memory 15 for storing the data, such as e.g. the consumption data, and for storing the first key 6 and the second key 7. The consumption meter 10 is extended by an additional, preferably one-way, data channel due to the additional second key 7 which serves to secure the second data channel 5. Alternatively or additionally, an additional transmission scheme can be provided for the data upload, so that e.g. a two-way communication can take place between the consumption meter 1 and the smart home controller 9 via the second data channel 5. As a result, for example, a dedicated configuration of the data content of the transmissions can also be performed by the smart home controller 9 via the second data channel 5.

As shown in FIG. 4, the consumer key or the second key 7 can be made available directly on the consumption meter 10, e.g. by means of a label 21, a stamp, an imprint, or via a display (not shown in FIG. 4 for the sake of clarity) which is preferably located on the consumption meter 10.

The design in FIG. 4 is furthermore a preferred design of a water meter according to the present invention, but the present invention is expressly not restricted to a design of this type, so that other types of water meter and also electricity meters, heat quantity meters or gas meters are also comprised by the present invention.

To summarize, potentially marketable added values and service features with which the satisfaction of the consumer 2 can be improved to a particular extent are offered to the supplier 3a at very little expense through the use of a consumption meter 1, 10 according to the invention or of the method according to the invention. For this purpose, the consumption meter 1, 10 of the supplier 3a is used to transmit a dedicated message with specific content and encryption for an additional receiver (second receiver 8) with the available means for data transmission. Due to the early separation of the communication channels or data channels as from the consumption meter 1, 10, the data are thus provided with an end-to-end encryption for all receivers 3, 8 and therefore an optimum timeliness and granularity of the data is selected. The first receiver 3 and the second receiver 8 are therefore independent.

Individual feature combinations (sub-combinations) and also possible combinations of individual features of different design forms not shown in the figures in the drawing are also expressly comprised by the content of the disclosure.

The following is a summary list of reference numerals and the corresponding structure used in the above description of the invention:
1 Consumption meter
1n Group of consumption meters
2 Consumer
3 First receiver
3a Supplier
4 First data channel
4n First data channel (for a group of consumption meters)
5 Second data channel
5n Second data channel (for a group of consumption meters)
6 First key
7 Second key
8 Second receiver
8n Group of second receivers
9 Smart home controller
10 Consumption meter
11 Control and evaluation unit
12 Transceiver device
13 Processor
14 Battery
15 Memory
16 Connection housing
17 Metering insert
18a Ultrasonic transducer
18b Ultrasonic transducer
19a Diverting device
19b Diverting device
20 Ultrasonic metering path
21 Label

1. A method for operating a consumption meter system, which comprises the steps of:
determining a consumption of a supply medium by a consumer using a consumption meter;
transmitting the consumption in a form of data between the consumption meter and a first receiver, the first receiver is assigned to a higher-level supplier, the data are transmitted between the consumption meter and the first receiver via a first data channel, and the data are encrypted on a meter side using a first key for transmission via the first data channel; and
transmitting, via a second data channel, the data between the consumption meter and a second receiver, the data are encrypted on the meter side for transmission via the second data channel by means of a second key.

2. The method according to claim 1, which further comprises encrypting the data on the meter side before transmission and the data are decrypted by the first receiver using the first key and/or by the second receiver using the second key after transmission.

3. The method according to claim 1, wherein the first key and/or the second key are a symmetric key or an asymmetric key.

4. The method according to claim 1, wherein the second receiver has a consumer application.

5. The method according to claim 1, wherein the second data channel is a one-way data channel via which the data are transmitted from the consumption meter to the second receiver.

6. The method according to claim 1, wherein the second data channel is a two-way data channel via which the data are transmitted between the consumption meter and the second receiver.

7. The method according to claim 1, which further comprises providing a data connection between the first receiver and the second receiver and the data connection is configured, to transmit the data from the first receiver to the second receiver so that the data are transmittable from the second receiver via the second data channel to the consumption meter.

8. The method according to claim 1, wherein the data, namely a selection of the data, which are transmitted via the second data channel are configurable by the consumer and/or the higher-level supplier.

9. The method according to claim 1, wherein the consumption meter is configurable via the first data channel and/or the second data channel.

10. The method according to claim 1, wherein the second key is extractable via and/or readable from the consumption meter.

11. The method according to claim 1, wherein the first data channel and/or the second data channel is a logical and/or physical data channel.

12. The method according to claim 1, wherein the data are consumption data and/or control data and/or operating data.

13. The method according to claim 1, which further comprises selecting the supply medium from the group consisting of gas, water, electricity and heat quantity.

14. The method according to claim 4, wherein the consumer application is a smart home controller.

15. A consumption meter for determining a consumption of a supply medium by a consumer, the consumption meter comprising:
means for determining the consumption;
an energy supply;
a control and evaluation unit configured to generate data from consumption values;
a transceiver device for transmitting the data; and
the consumption meter configured to transmit the data via a first data channel between the consumption meter and a first receiver, and to encrypt the data by means of a first key for transmission via the first data channel, the consumption meter further configured to transmit the data via a second data channel between the consumption meter and a second receiver, and to encrypt the data by means of a second key for transmission via the second data channel.

16. The consumption meter according to claim 15, wherein said means for determining consumption contains a metering configuration for determining a flow rate of a fluid, an input and/or extracted heat energy or an amount of the input and/or an extracted electrical quantity.

17. The consumption meter according to claim 15, further comprising a memory for storing the data and/or the first key and/or the second key.
